(19) United States
(12) Patent Application Publication
(10) Pub. No.: US 2023/0249652 A1
(43) Pub. Date: Aug. 10, 2023

(54) EXTERNAL CAR HEATER SYSTEM

(71) Applicant: ISAIAH D'ANGELO LEVI, CLEVELAND, TX (US)

(72) Inventor: ISAIAH D'ANGELO LEVI, CLEVELAND, TX (US)

(21) Appl. No.: 17/665,244

(22) Filed: Feb. 4, 2022

(51) Int. Cl. B60S 1/66; B60R 16/033; B60R 16/03; H05B 1/02

(52) U.S. Cl. CPC B60S 1/66; B60R 16/033; B60R 16/0307; H05B 1/0236; H05B 2214/02

(57) ABSTRACT

An external car heater system includes a panel section located on an external surface of an automobile. The panel section is regulated through a control unit to turn on/off heat. The system may be regulated via manual user input or through automated processes. A sensor is used to monitor external conditions of the environment around the vehicle and can detect at least temperature. Sensor data is transmitted to the control unit to regulate the heating elements. The heat generated through the heating elements are used to melt ice and snow beneath the vehicles to move.

### BACKGROUND OF THE INVENTION

### 1. Field of the Invention

The present application relates to a heater system, and more particularly to an external heater for an automobile to melt ice and snow.

### 2. Description of Related Art

It is common in a lot of areas to incur freezing temperatures throughout portions of the year. Ice and snow can be common and are a hinderance to drivers. Accumulated ice and snow can prevent drivers from moving a vehicle. Conventional methods to clear the ice and snow involve using shovels, ice shovels, snow blowers, heating wires in the driveway and being towed out of the snow. Their limitations/disadvantages are having to be outside in the cold wasting a lot of time/energy and at times can be dangerous. Although heating elements have been used to heat areas external to an automobile, shortcomings remain. It is desired that an assembly be provided that is configured to melt ice and snow outside the vehicle adjacent the wheels.

### BRIEF SUMMARY OF THE INVENTION

It is an object of the present application to provide an external heater system for an automobile, such as a car or truck. The system locates a panel section composed of a heating element and a thermally conductive material to radiate thermal energy to directed areas around the automobile. It is desired that the system include sensors to automatically detect external temperatures and the accumulation of snow/ice.

It is a further object of the present application that the system be automated to track, monitor and detect without input from a user. Additionally the heating elements may be regulated through a control unit. The heating elements may come on in response to detected sensor outputs or through manual manipulation of the user.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of an external car heater system according to an embodiment of the present application.

FIG. 2 is a bottom view of the external car heater system of FIG. 1.

FIG. 3 is a side view of a representation of a panel section used in the system of FIG. 1.

FIG. 4 is a chart of the external car heater system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the heated car system of the present application is configured to regulate the performance of one or more externally mounted panel sections containing one or more heating elements. The system is configured to melt the ice/snow around the tires of the vehicle to allow a user to avoid getting stuck. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The external car heater system includes a panel section located on an external surface of an automobile. The panel section is regulated through a control unit to turn on/off heat. The system may be regulated via manual user input or through automated processes. A sensor is used to monitor external conditions of the environment around the vehicle and can detect at least temperature. Sensor data is transmitted to the control unit to regulate the heating elements. Additional features and functions are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

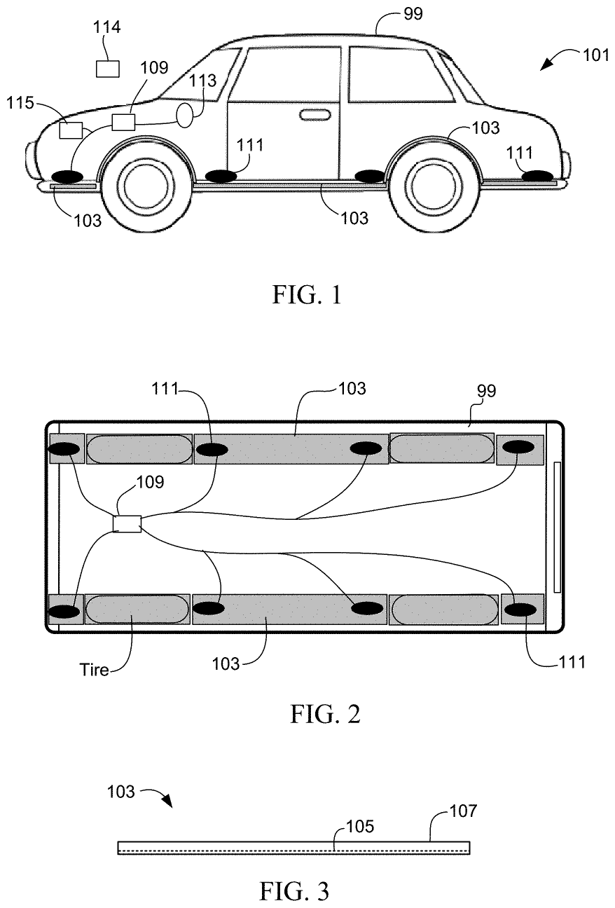

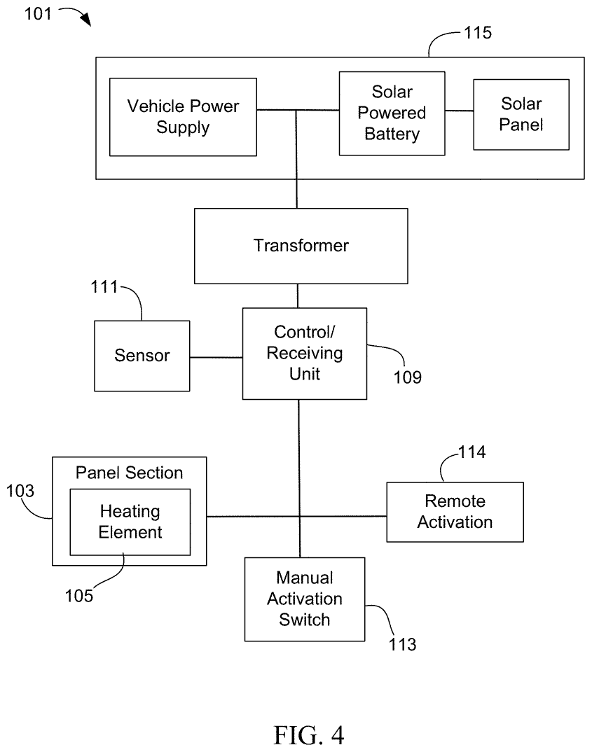

Referring now to FIGS. 1-3 in the drawings, views of an external car heater system 101 are provided. System 101 is configured to regulate the activation of one or more heating elements designed to broadcast heat beneath the automobile. The system is configured to melt the ice/snow beneath the car to allow the car to move forward and/or backward. This helps to alleviate the need for the user of the car to get out and manually break up or remove the snow/ice.

As seen in FIG. 1, an automobile 99, such as a car or truck, is shown having system 101 installed thereon. System 101 includes a panel section 103 externally located on an underside of automobile 99 and configured to selectively broadcast heat away from the automobile. The panel section 103 is shown more clearly in FIG. 3. The panel sections 103 are comprised of a heating element 105 embedded in a thermally conductive material 107 which radiates thermal energy produced heat via element 105 to be broadcast away from the vehicle toward the wheel wells and pavement. Material 107 is attached to a lower peripheral side section of the automobile such as the frame, body panel, structure, and so forth. Heat generated through element 105 is reflected or directed away from the car.

A plurality of sections 103 are used and located in different spots. Ideally these sections are located on the underside of the car and extend fore, aft, and between the tires along the length of the car on each side. As system 101 is designed to heat the underside of the car to melt ice/snow and drive away; it is desired that panel sections 103 be either sized to be as wide as the tires or that more than one panel section 103 be oriented side by side to at least cover the width of the tires. It is understood that sections 103 may be located in the wheel wells of the car and can therefore be flexible or shaped with a curved contour to match the wheel wells.

The panel sections 103 are coupled together and routed through control unit 109. Unit 109 is used to regulate performance of panel sections 103 and in particular heating elements 105. System 101 also includes one or more sensors 111 located around the exterior of the automobile and are used to provide data to unit 109 related to external conditions around the automobile. Sensors 111 may be used to monitor temperature, snow or ice formation, moisture level, and other environmental conditions. Use of sensors 111 help to provide a feedback system which operates in real time by monitoring the environmental conditions. As heating elements 105 function, the environmental conditions beneath the car change and reported to unit 109.

The user is optionally provided with updates from sensors 111. System 101 is operable in a manual mode or in an automatic mode. In manual mode, the user interfaces with an activation device 113 located in the automobile, such as on the dash, or through a mobile device 114. The user can get readings and check the health and operation of the system. The user can activate the heating elements and turn them off as needed. In an automatic mode, system 101 continuously monitors the environmental conditions and selectively activates the heating elements when conditions warrant it. Such conditions may include freezing temperatures, elevated surface beneath the car to refer to ice or snow accumulation. Control unit 109 may even allow the user to interact with and control functions of system 101, such as settings, timers, heat levels, and so forth. In cases where a mobile device is used, remote access and activation are possible. Remote referring to when the user is not in the automobile.

System 101 may be powered by one or more methods. System 101 is coupled to a power supply 115 to provide the electrical energy to power heating elements 105. Different methods may be used. Power supply 115 may be that of the automobile's battery. It may be a separate battery in other embodiments. It may be charged from the automobile's alternator and charging system. In another method, solar panels and solar powered batteries may be used to supply the power. In general either the automobile electrical system may provide the power or an alternate form of power may be provided.

In a preferred embodiment of the present invention, the apparatus comprises a feedback system which operates by real time monitoring of temperature and moisture levels above freezing point until the snow/icy mass buildup is removed. A controlled heat system through panels 103 are installed directly in-line with the fender wells, from end to end of the vehicle, on the bottom side of the body parts, and with ample width to accommodate the tire-width used on the vehicle. The heat can be derived from, electricity, or any conductive continuous loop, or zoned by using an alternating controller installed “After Market” by means of mechanical fasteners, or with chemical adhesive or at “manufacturing” by incorporating the “Heat Elements” into the body parts.

Use of system 101 will allow the vehicle to avoid being stuck in snow/ice in the future all with the convenience of not having to necessitate the user getting out of the car or arriving at the car until the area is thawed. It should be noted that wireless communications are permitted within system 101 and with remote devices.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An external car heater system, comprising:
a panel section containing at least one heating element;
a control unit configured to regulate operation of the panel section;
a sensor in communication with the control unit and configured to monitor environmental conditions near the car; and
a power supply to provide energy to the heating elements so as to melt ice and snow beneath the car.

2. The system of claim 1, wherein the panel section includes a thermally conductive material.

3. The system of claim 2, wherein the panel section is configured to radiate the heat from the heating element away from the car.

4. The system of claim 1, wherein the control unit continuously monitors environmental conditions around the car.

5. The system of claim 1, wherein the control unit is manually operated via an interface in the car.

6. The system of claim 1, wherein the control unit is communicable with remote devices through wireless communications.

7. The system of claim 1, wherein the sensor monitors at least one of temperature, moisture levels, and distance.

8. The system of claim 1, wherein the power supply is provided through a battery

9. The system of claim 8, wherein the battery is used to supply power to the car.

10. The system of claim 8, wherein the battery is separate from the charging system of the car

11. The system of claim 8, wherein the power supply is a solar power system.

12. The system of claim 1, wherein the panel section is as wide as a tire on the car.

13. The system of claim 1, wherein the panel section is flexible.

14. An external car heater system, comprising:
a car having a wheel well and a tire;
a panel section containing at least one heating element;
a control unit configured to regulate operation of the panel section;
a sensor in communication with the control unit and configured to monitor environmental conditions near the car; and
a power supply to provide energy to the heating elements so as to melt ice and snow beneath the car.

15. The system of claim 14, wherein the control unit continuously monitors environmental conditions around the car.

16. The system of claim 14, wherein the control unit is manually operated via an interface in the car.

17. The system of claim 14, wherein the power supply is provided through a battery.

18. The system of claim 17, wherein the battery is used to supply power to the car.

19. The system of claim 17, wherein the battery is separate from the charging system of the car.

20. The system of claim 14, wherein the panel section is as wide as the tire on the car.
